(19) United States
(12) Patent Application Publication
(10) Pub. No.: US 2015/0098390 A1
(43) Pub. Date: Apr. 9, 2015

(54) PRIORITIZATION OF DATA TRAFFIC BETWEEN A MOBILE DEVICE AND A NETWORK ACCESS POINT

(71) Applicant: VONAGE NETWORK LLC, Holmdel, NJ (US)

(72) Inventor: Tzahi Efrati, Hoboken, NJ (US)

(73) Assignee: VONAGE NETWORK LLC, Holmdel, NJ (US)

(21) Appl. No.: 14/046,007

(22) Filed: Oct. 4, 2013

(51) Int. Cl. H04W 28/02; H04W 72/02

(52) U.S. Cl. CPC H04W 28/0215; H04W 72/02
USPC 370/329

(57) ABSTRACT

Methods for prioritizing data traffic between a mobile device and a network access point are provided herein. In some embodiments, a method for prioritizing data traffic between a mobile device and a network access point may include: receiving information associated with bandwidth usage for a plurality of user applications that are running on one or more computing devices connected to the network access point; accessing the network access point via a controller application disposed on one of the computing devices; and granting, by the controller application, bandwidth allocations for each of the user applications over a first time period based on at least some of the information associated with the bandwidth usage.

### FIELD

Embodiments of the present invention generally relate to methods and systems for prioritization of data traffic between a mobile device and a network access point.

### BACKGROUND

Generally, a mobile device receives connectivity to a data network such as the Internet through a single connection, such as a wireless access point. This can be a wireless router or a cellular base station, for example.

The downstream and upstream bandwidth of the access point is limited. There are limits on the total data capacity of the access point to serve all connected devices that are currently in communication with the access point. For example, a wireless router is limited by both the Internet connection and its own physical capabilities. To ensure fairness across devices, there may also likely be limits on the maximum or average downstream and upstream bandwidths allotted to a given device.

A mobile device will thus have a single connection that's limited in both the downstream and upstream direction. Yet, with today's smartphones, the user may be using that single connection for multiple applications. The different applications will have different levels of sensitivity and needs as respects bandwidth. For example: a video calling app would need a relatively high amount of bandwidth maintained at a relatively constant level; a voice-only calling app would need only a modest amount of bandwidth, yet still maintained at a relatively constant level; a file download might need a high amount of bandwidth, yet it could be flexible in how and when the bandwidth is needed; or a game might also need a high amount of bandwidth, there would be some flexibility in the consistency of bandwidth needed, and the amount of bandwidth needed might also vary in real-time based on how the game progresses.

Currently, there are well-known means for controlling traffic at the access point. More specifically, modern-day routers can prioritize traffic based on traffic type. For example, VoIP calls may be prioritized over file downloads.

However, these methods are limited in that they generally only allow for a strict prioritization of traffic based on application type. They do not, for example, allow the user to indicate which applications should be prioritized and how. Moreover, they do not allow for more sophisticated allocation of resources as between applications on the same or different mobile devices that might be accomplished based on an understanding of the current and predicted status of various running applications.

Accordingly, there exists a need for improved methods and systems for prioritization of data traffic between a mobile device and a network access point.

### SUMMARY

Methods for prioritizing data traffic between a mobile device and a network access point are provided herein. In some embodiments, a method for prioritizing data traffic between a mobile device and a network access point may include: receiving information associated with bandwidth usage for a plurality of user applications that are running on one or more computing devices connected to the network access point; accessing the network access point via a controller application disposed on one of the computing devices; and granting, by the controller application, bandwidth allocations for each of the user applications over a first time period based on at least some of the information associated with the bandwidth usage.

Methods for prioritizing data traffic between a mobile device and a network access point are provided herein. In some embodiments, a method for prioritizing data traffic between a mobile device and a network access point may include: accessing configuration settings of the network access point via a first application disposed on the mobile device; and setting, via the first application, a priority of a flow of data traffic from a second application that has sent, or will send, data through the network access point to be different than a priority of a flow of data traffic from a third application that has sent, or will send, data through the network access point.

In some embodiments, an apparatus for prioritizing data traffic between a mobile device and a network access point may include at least one processor, at least one input device, and at least one storage device storing processor-executable instructions which, when executed by the at least one processor, performs a method. The method performed may include receiving information associated with bandwidth usage for a plurality of user applications that are running on one or more computing devices connected to the network access point; accessing the network access point via a controller application disposed on one of the computing devices; and granting, by the controller application, bandwidth allocations for each of the user applications over a first time period based on at least some of the information associated with the bandwidth usage.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for prioritizing data traffic between one or more computing devices and a network access point, according to one or more embodiments.

FIG. 2 depicts a block diagram of a computing device and network access point, according to one or more embodiments.

FIG. 3 depicts a flow diagram of a method for prioritizing data traffic between one or more computing devices and a network access point, according to one or more embodiments;

FIG. 4 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods for prioritization of data traffic between a mobile device and a network access point. In some embodiments described herein, an application or software running on a device (such as a mobile device) interacts with the network access point and with other applications running on that device or other devices. The application can be a controller application that may be part of the O/S, included as a combination of software/hardware, or it could be a third-party app installed on the device. The controller will interface directly with the router or indirectly via a cloud-based network proxy server. In embodiments consistent with the present invention, the controller has permission to grant, bandwidth allocations to applications. In some embodiments, granting bandwidth allocations further includes prioritizing and scheduling the allocated bandwidth between applications. The controller obtains information about applications that may be running, and has the ability to instruct the access point on how to allocate bandwidth to the applications over time.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

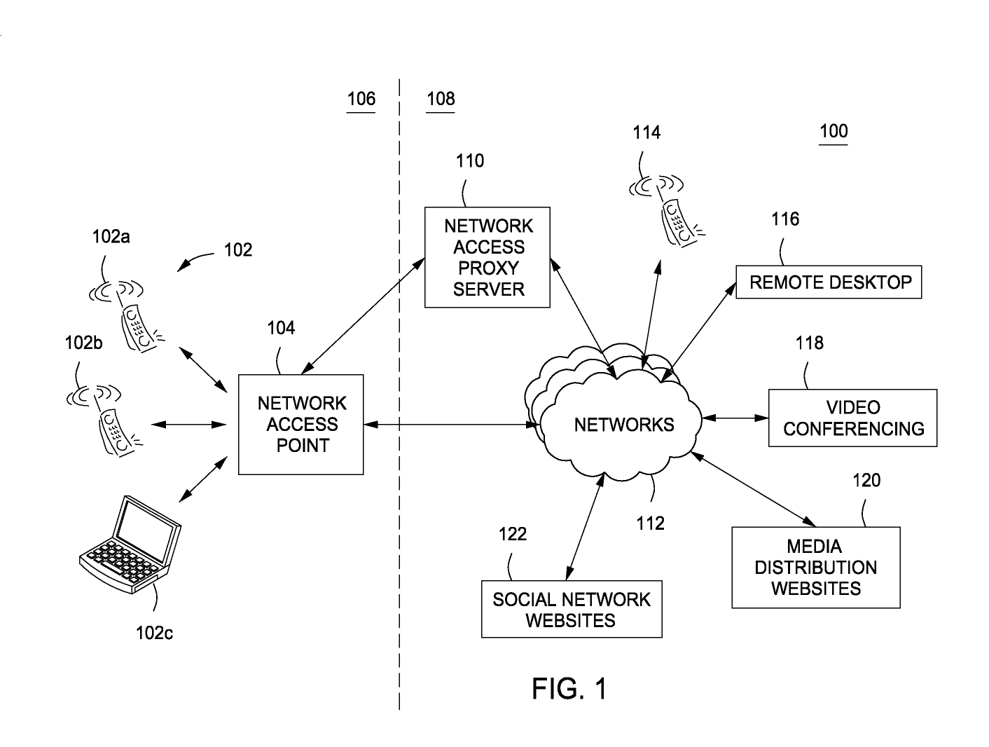

FIG. 1 depicts a block diagram of a system 100 for prioritization of data traffic between a mobile device and a network access point in accordance with embodiments consistent with the present application. The system 100 includes one or more end-user devices 102 such as mobile computing devices 102a, 102b, and 102c. The mobile computing devices 102a-c may be communicatively coupled to a network access point 104 on a local area network (LAN) 106. Network access point 104 may be a wireless router and provide a wireless access point to mobile devices 102a-c. In some embodiments, network access point 104 provides a single egress/ingress between mobile computing devices 102a-c and wide area network (WAN) 108. In some embodiments, network access point 104 may be communicatively coupled to a network access proxy server 110 that provides a single point of egress/ingress between LAN 106 and WAN 108. For example, network access proxy server 110 may be in an ONAVO compression server, or the like.

WAN 108 may include one or more networks 112 communicatively coupled to one or more mobile devices 114, remote desktops 116, videoconferencing services 118, media distribution websites 120, social network websites and services 122, and the like.

The networks 112 comprise one or more communication systems that connect computers by wire, cable, fiber optic and/or wireless link facilitated by various types of well-known network elements, such as hubs, switches, routers, and the like. The networks 112 may include an Internet Protocol (IP) network, a public switched telephone network (PSTN), or other mobile communication networks, and may employ various well-known protocols to communicate information amongst the network resources.

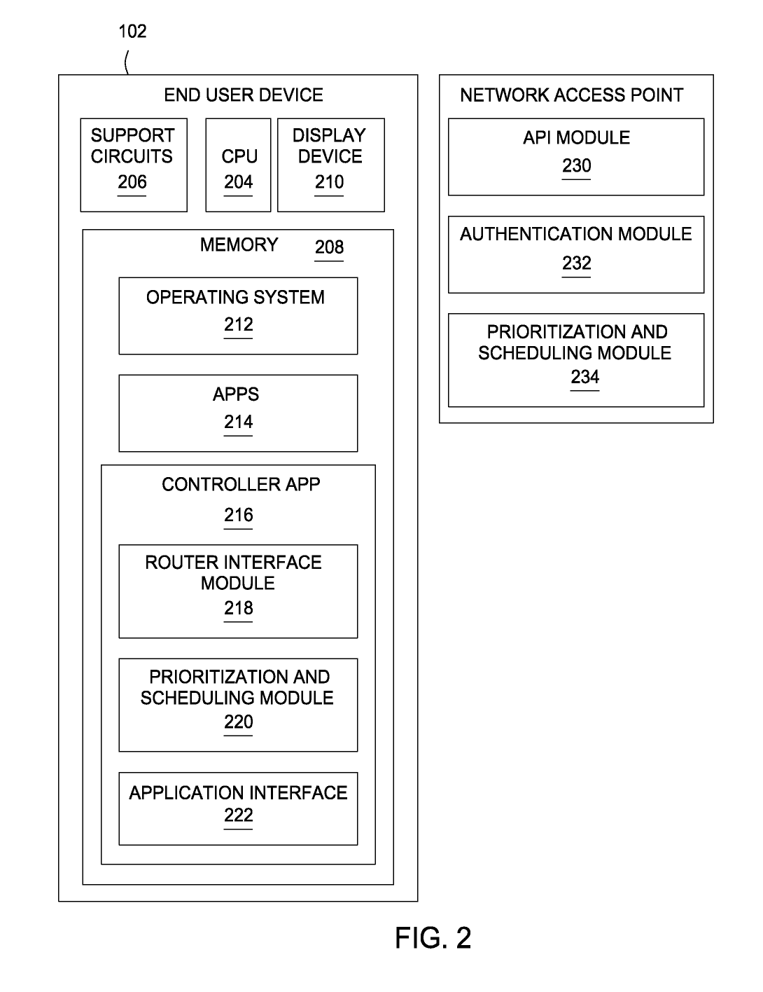

As shown in FIG. 2, the end-user device 102 comprises a Central Processing Unit (CPU) 204, support circuits 206, memory 208, and the display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output circuits, and the like. The memory 208 comprises at least one of Read Only Memory (ROM), Random Access Memory (RAM), disk drive storage, optical storage, removable storage and/or the like. In some embodiments, the memory 208 comprises an operating system 212, miscellaneous installed apps 214 and a controller app 216 for interfacing with a network access point (e.g., network access point 104 or network access proxy server 110) and for granting, prioritizing and/or scheduling bandwidth allocations to the miscellaneous installed apps 214 on end-user device 102, and other end-user devices (such as mobile computing devices 102a-102c).

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, various versions of LINUX, MAC OSX, BSD, UNIX, MICROSOFT WINDOWS, 10S, ANDROID and the like.

The miscellaneous installed apps 214 may include, but are not limited to, for example, Voice over Internet Protocol (VoIP) apps, video teleconferencing apps, social media apps (such as TWITTER, FACEBOOK, etc.), video streaming apps (such as YOUTUBE, etc.), remote desktop apps, gaming apps, and the like.

The controller app 216 is a control and monitoring application made available to the end-user and is described below in more detail. The end-user that access the control app may typically be an administrative user that possesses the secure authentication information required to login and configure the network access point 104 (or an account on network access proxy server 110). In some embodiments, an end-user may download the controller app 216 from a service provider associated with an application installed on the end-user device 102 (e.g., a VoIP service provided associated with a VoIP app installed on the end-user device), or a distribution system associated with a service provider or the network access point manufacturer. Although the controller app 216 is described herein as a separate stand-alone application, in some embodiments the controller app 216 may be integrated into OS 212, and may use existing application programming interface (API) calls provided by the OS 212 to obtain information regarding applications installed on the end-user device 102. In some embodiments, a software development kit (SDK) may be provided by the controller app 216, such that application 214 may use the SDK to request that the controller app 216 prioritize their data, otherwise convey to the controller app 216 requested prioritization for data transmitted by application 214, or convey to the controller app 216 information regarding the bandwidth usage (or anticipated bandwidth usage) of the application 214.

The controller app 216 may include a router interface module 218 to communicate with network access point 104. The controller app 216 may also include a prioritization and scheduling module 220 to grant, prioritize and/or schedule bandwidth allocations to applications running on end-user device 102 or other applications running on other end-user devices connected to network access point 104. In some embodiments, the controller application 216 may also include an application interface 222 to obtain information from one or more applications running on end-user device 102, and/or applications running on other end-user devices connected to network access point 104.

The network access point 104 may include an API module 230, authentication module 232, and a prioritization and scheduling module 234. In some embodiments, the prioritization and scheduling module 234 may include a list of running applications disposed on devices connected to the network access point 104. In some embodiments the prioritization and scheduling module 234 may also include a list of applications that have sent/received data, or will send/receive data, through the network access point 104.

In operation, in embodiments consistent with the present invention, network access point 104, and/or network access proxy server 110, may prioritize, schedule, or otherwise place limits on the maximum or average downstream and upstream bandwidth allotted to applications running on each mobile computing device 102a-c on LAN 106, based on information provided by controller app 216. For example, in some embodiments, the controller at 216 may receive information about one or more applications that are running on one or more end-user devices connected to the network access point (e.g., via application interface 222). In some embodiments, controller app 216 may determine an amount of network bandwidth required by each of the one or more running applications. In some embodiments, determining the amount of bandwidth required by the one or more running applications includes determining a predicted bandwidth that will be required by the one or more running applications over the first time period. For example, the predicted bandwidth may be determined based on previous bandwidth use by the application, the controller might recognize peaks in bandwidth consumption at certain times by applications, and the like. In some embodiments, the applications may request a certain amount of bandwidth over a specified time period. In addition, predicted bandwidth may be determined by parsing meta-information to extract pertinent bandwidth information, such as, but not limited to, the duration of streamed video content or the types of coder-decoders (codecs) used in a video session.

After determining the amount actual and predicted bandwidth required, the end-user device 102 may access the network access point via router interface module 218 of controller at 216. In some embodiments, the controller application 216 receives authorization from an administrative user of the network access point to adjust the priority and schedule of applications sending and receiving data via the network access point. In some embodiments, the authorization received is in a form of secure network access point login information to access and administrative account associated with the control app. In some embodiments, instead of receiving or requesting the router's secure access credentials, an open standard for secure authentication may be used. For example, in some embodiments, OAUTH may be used where an end-user provides the controller app 216, or one or more of apps 214, permission to prioritize traffic.

In some embodiments, a plurality of devices are associated with the administrative account to set priority and schedule information. That is, a plurality of different end user devices 102 may each have a controller application 216 installed with the proper administrative authorization to access an administrative account that allows the granting, prioritization and scheduling of bandwidth allocations on the network access point 104.

The prioritization and scheduling module 220 may then grant, prioritize and/or schedule bandwidth allocations on the network access point via prioritization and scheduling module 234 for each of the one or more running applications over a predetermined time period. In some embodiments, an authorized user of the controller application sets minimum Quality of Service (QoS) parameters for specific application or types of applications. For example, the QoS parametrs may mandate that a video call may never be degraded below a certain level (i.e., be allocated a certain minimum allocation of bandwidth to meet certain QoS parameters), or that audio on a call must be guaranteed above all else. Additional non-limiting examples may include that games should take priority if they are in the foreground, keeping TCP connection open longer than a default timeout, and the like.

In addition, the information about one or more applications includes a minimum level of performance required by the applications, and wherein the controller application further grants, prioritizes and/or schedules bandwidth allocations based on the minimum level of performance required by the applications. The minimum level of performance required by each application may be set by the application developer and stored with the application, which then can be accessed by application interface 222. For example, a minimum bandwidth of about 7000 kbps to about 8000 kbps may be set for a 1080p H.264 codec used in a video session. In some embodiments, the controller application sets a default priority to each application based on application type.

In some embodiments, the controller application 216 may include a graphical user interface to allow an end-user to adjust priorities and scheduling information.

If certain conflicts regarding priority and schedule exist, the controller application may receive one or more alerts from the network access point. For example, when at least one of prioritization conflicts exists or when minimum Quality of Service parameters cannot be met, the network access point 104 may send an alert to controller application 216.

In some embodiments, the controller application 216 grants, prioritizes and/or schedules bandwidth allocation via Application Programming Interface (AP) calls to the network access point. In alternative embodiments, one or more of the applications 214 installed on an end-user device 102 may access an API provided by the controller app 216, or a software development kit (SDK) provided by the controller app 216, to request that the controller app 216 prioritize their data. For example, a video teleconferencing app may access an SDK of the controller application to request that the controller application prioritize video conferencing data of the video teleconference app. In addition, the app may also request to stop prioritization once it's no longer needed. Alternatively, the controller app may have maximum duration for prioritized app bandwidth.

In some embodiments, prioritization may be based on connection type. Specifically, in some embodiments, some applications may have priority access to a Wi-Fi connection, if available, while other applications are directed to using a cellular network or other type of wireless connection. For example, in some embodiments, a high bandwidth usage application such as a video teleconferencing application may have priority access to a Wi-Fi connection, while lower bandwidth applications such as weather applications may be directed to using a cellular network for transmitting information.

Although described in terms of the network access point 104 disposed on local area network 106, the network access proxy server 110 functions similarly to the network access point 104. That is, for example, network access proxy server 110 may include an API authentication module and a prioritization and scheduling module for performing the same functions described above as network access point 104. The network access proxy server 110 may be disposed on a wide area network (WAN) and provides the one or more end-user devices a single ingress/egress access point to other portions of the WAN.

In further embodiments, an application running on end-user device 102, such as for example apps 214 or controller app 216, may access configuration settings of the network access point 104 or network access proxy server 110. The application may set a priority of a flow of data traffic from one or more applications that have sent, or will send, data through the network access point to be different than a priority of a flow of data traffic from other applications that have sent, or will send, data through the network access point. Setting data traffic priorities include instructing the network access point on how to allocate bandwidth to the second and third applications over time. In some embodiments, setting the traffic priorities further includes obtaining a list of applications that have sent, or will send, data through the network access point, and prioritizing a flow of data traffic from at least one application on the list over at least one other application on the list. The priority of the flow of data traffic of one or more applications may be set higher than the priority of the flow of data traffic of other applications. A higher priority application may be allocated more bandwidth than a lower priority application; or its bandwidth needs may be addressed before addressing the needs of a lower priority application.

In some embodiments, the application setting the priority may adjust its own priority setting on network access point 104, or network access proxy server 110.

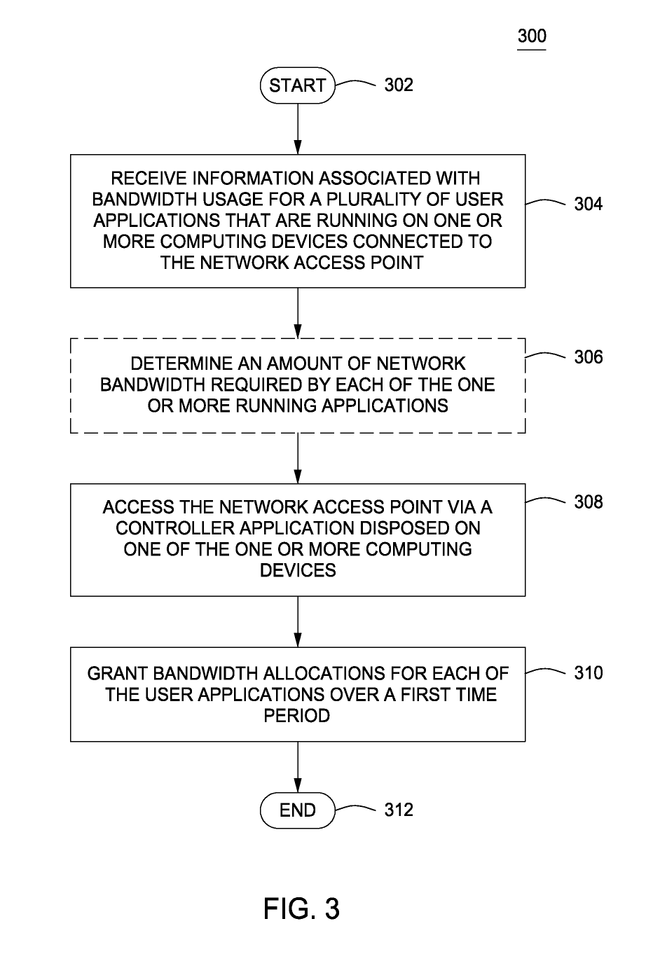

Exemplary methods that may be performed by one or more elements of system 100 for prioritizing data traffic between one or more computing devices and a network access point are described below with respect to FIG. 3. The method 300 in FIG. 3 starts at 302 and proceeds to 304. At 304, information associated with bandwidth usage for a plurality of user applications that are running on one or more computing devices connected to the network access point may be received. In some embodiments that information may be obtained via API or SDK calls to or from the running applications. In some embodiments, based on the information received an amount (and/or timing) of network bandwidth required by each of the one or more running applications may optionally be determined at 306. In some embodiments, this determination may be made by a controller app running on an end-user device such as a mobile device. In other embodiments, the individual applications may determine and indicate their individual bandwidth needs to the controller app in the received information associated with bandwidth usage, and thus, a separate determination may not need to be made. At 308, the controller app, for example, may access the network access point disposed on the one or more computing devices. After accessing the network access point, the controller app may grant bandwidth allocations for each of the one or more running applications over a specific time period at 310. In some embodiments, granting bandwidth allocations for each of the user applications includes prioritizing and/or scheduling bandwidth allocations for each of the user applications. In some embodiments, the controller app may receive a response from the network access point that confirms the prioritization and bandwidth request, or indicates the priority and bandwidth that can be provided. The method ends at 312.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

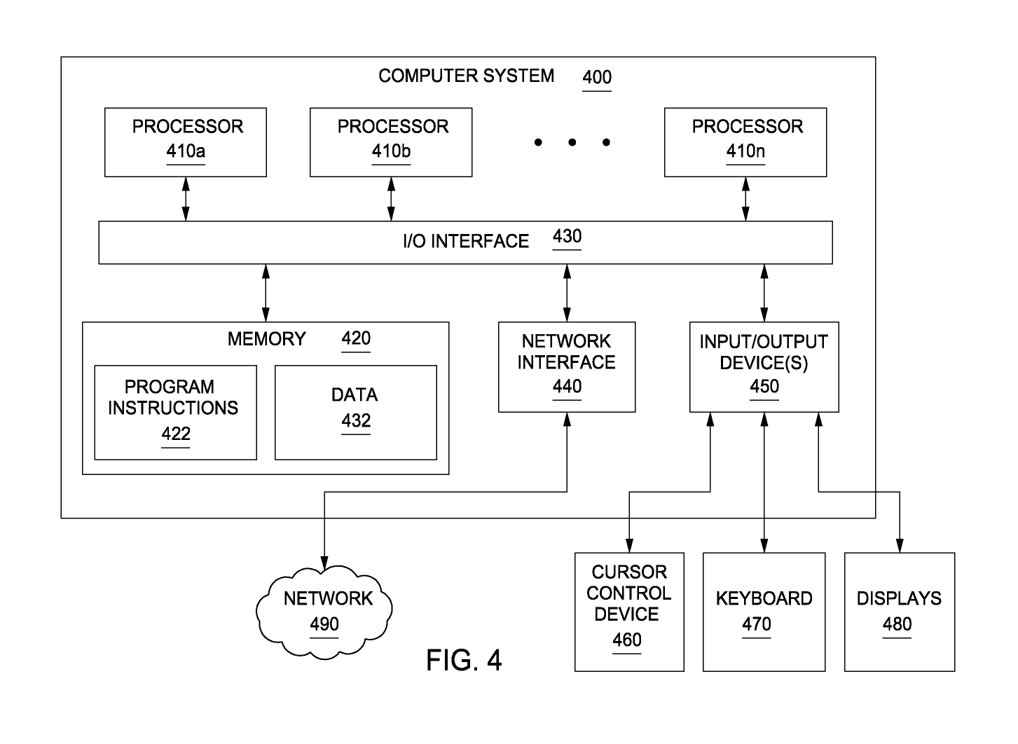

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for prioritizing data traffic between one or more computing devices and a network access point, comprising:
receiving information associated with bandwidth usage for a plurality of user applications that are running on one or more computing devices connected to the network access point;
accessing the network access point via a controller application disposed on one of the computing devices; and
granting, by the controller application, bandwidth allocations for each of the user applications over a first time period based on at least some of the information associated with the bandwidth usage.

2. The method of claim 1, wherein granting bandwidth allocations for each of the user applications includes at least one of prioritizing or scheduling bandwidth allocations for each of the user applications.

3. The method of claim 1, further comprising:
determining an amount of network bandwidth required by each of the one or more running applications based on at least some of the information associated with the bandwidth usage.

4. The method of claim 1, further comprising determining a predicted bandwidth that will be required by at least one of the user applications over the first time period.

5. The method of claim 1, wherein the controller application received authorization to grant bandwidth allocations for user applications running on devices connected to the network access point.

6. The method of claim 5, wherein the authorization received is in a form of secure network access point login information.

7. The method of claim 5, wherein a plurality of devices are associated with the controller application to grant bandwidth allocations.

8. The method of claim 5, wherein an authorized user of the controller application sets minimum Quality of Service parameters for specific application or types of applications.

9. The method of claim 1, wherein the information about one or more applications includes a minimum level of performance required by the applications, and wherein the controller application further grants bandwidth allocations based on the minimum level of performance required by the applications.

10. The method of claim 1, wherein the controller application sets a default priority to each application based on application type.

11. The method of claim 1, wherein the controller application receives alerts from the network access point when at least one of prioritization conflicts exists or when minimum Quality of Service parameters cannot be met.

12. The method of claim 1, wherein the controller application grants bandwidth allocation via Application Programming Interface (API) calls to the network access point.

13. The method of claim 1, wherein network access point is a wireless router disposed on a local area network (LAN) and provides a single ingress/egress access point to a wide area network (WAN).

14. The method of claim 13, wherein the one or more computing devices are disposed on the LAN.

15. The method of claim 1, wherein network access point is a network access proxy server disposed on a wide area network (WAN) and provides the one or more computing devices a single ingress/egress access point to other portions of the WAN.

16. A method for prioritizing data traffic between a mobile device and a network access point, comprising:
accessing configuration settings of the network access point via a first application disposed on the mobile device; and
setting, via the first application, a priority of a flow of data traffic from a second application that has sent, or will send, data through the network access point to be different than a priority of a flow of data traffic from a third application that has sent, or will send, data through the network access point.

17. The method of claim 16, wherein setting data traffic priorities includes instructing the network access point how to allocate bandwidth to the second and third applications over time.

18. The method of claim 16, wherein the first application received authorization from an administrative user of the network access point to adjust the priority of a flow of data traffic from applications that have sent, or will send, data traffic through the network access point.

19. The method of claim 16, wherein setting the priority further includes:
obtaining a list of applications that have sent, or will send, data through the network access point; and
prioritizing a flow of data traffic from at least one application on the list over at least one other application on the list.

20. The method of claim 16, wherein the priority of the flow of data traffic of the second application is set higher than the priority of the flow of data traffic of the third application.

21. The method of claim 20, wherein a higher priority application is allocated more bandwidth than a lower priority application.

22. The method of claim 21, wherein the first application is the same as the second application.

23. Apparatus for prioritizing data traffic between a mobile device and a network access point, comprising:
a) at least one processor;
b) at least one input device; and
c) at least one storage device storing processor-executable instructions which, when executed by the at least one processor, performs a method including
1) receiving information associated with bandwidth usage for a plurality of user applications that are running on one or more computing devices connected to the network access point;
2) accessing the network access point disposed on one of the computing devices; and
3) granting bandwidth allocations for each of the user applications over a first time period based on at least some of the information associated with the bandwidth usage.
